(19) United States
(12) Patent Application Publication
(10) Pub. No.: US 2025/0162437 A1
(43) Pub. Date: May 22, 2025

(54) CHARGING ASSEMBLY FOR AN AUTONOMOUS-NAVIGATION VEHICLE WITH SAFETY MONITORING

(71) Applicant: EZ-WHEEL, LA COURONNE (FR)

(72) Inventors: Florian GARDES, GOND-PONTOUVRE (FR); Antoine JUAN, ANGOULEME (FR)

(21) Appl. No.: 18/840,180

(22) PCT Filed: Feb. 22, 2023
(86) PCT No.: PCT/FR2023/050248

§ 371 Date: Aug. 21, 2024

(30) Foreign Application Priority Data
Feb. 22, 2022 (FR) 2201552

(51) Int. Cl. B60L 53/36; B60L 3/04; B60L 53/66; B60L 53/67; B60W 60/00; H02J 7/00

(52) U.S. Cl. CPC B60L 53/36; B60L 3/04; B60L 53/66; B60L 53/67; B60W 60/0015; H02J 7/00034; B60W 2556/45

(57) ABSTRACT

A charging assembly for autonomous vehicles including: a charging docking station arranged fixedly in a working area, the charging docking station including a battery charger, a first operating safety monitor that generates and transmits operating safety information, and a first wireless communication transmitter that receives the operating safety information and generates and transmits a safety frame comprising the operating safety information; an autonomous-navigation vehicle configured to move in the working area, the vehicle includes a rechargeable electric battery able to be electrically connected to the battery charger, a second operating safety monitor connected to the rechargeable electric battery, and a second wireless communication transmitter configured to receive the safety frame including the safety information transmitted by the first wireless communication transmitter and to transmit the safety information to the second operating safety monitor, the second operating safety monitor being configured to process said operating safety information.

### CROSS REFERENCE TO RELATED APPLICATIONS

This application is a National Stage of International Application No. PCT/FR2023/050248, having an International Filing Date of 22 Feb. 2023, which designated the United States of America, and which International Application was published under PCT Article 21(2) as WO Publication No. 2023/161585 A1, which claims priority from and the benefit of French Patent Application No. 2201552 filed on 22 Feb. 2022, the disclosures of which are incorporated herein by reference in their entireties.

### BACKGROUND

### Field

The present disclosure generally relates to charging assemblies for autonomous automated guided vehicles (AGV's) and, more particularly, to self-docking and charging assemblies for autonomous-navigation vehicles.

### Brief Description of Related Developments

The use of automated guided vehicles (AGV's) is becoming increasingly widespread in various industrial fields. In retail storage warehouses, for example, picking trolleys are used to replenish stock or pick items from the warehouse for a customer order. The vehicles use geo-guidance technologies to move autonomously and freely in an environment with no human intervention and no external elements.

Autonomous vehicles are currently equipped with an on-board battery which is charged on a docking base or docking station. In order to limit human intervention for tasks such as battery charging, autonomous vehicles are configured to determine the position of the docking station in order to be able to dock there autonomously by virtue of guidance means.

The vehicles are guided, for example, by wires that impose a fixed trajectory and a specific infrastructure. In order not to impede the movement of the autonomous vehicles, the wires are generally buried under the floor of the working area, making the installation expensive. If the wires are installed on the surface, they may be damaged by the vehicle itself or by other machines travelling in the working space. Moreover, the installation of the wires needs to be modified when the location of the docking stations is modified.

Another solution consists in equipping docking stations with a beacon or a laser beam emitter for guiding the autonomous vehicles. However, such technology also has many limitations.

Furthermore, in factories and warehouses, there may be operators and other vehicles in motion. In such dynamic environments, it is therefore essential to be able to control the trajectory of the autonomous vehicle in order to ensure its correct operation while ensuring the safety of the operators in motion, during the phase of performing its tasks but also during the phase in which the autonomous vehicle is moving towards the docking station to charge its battery. Conventional docking stations are not able to guide the movement of autonomous vehicles and stop them in the event of obstacles being detected along their trajectory. Safety information is processed by radio transmission safety systems which are separate from the docking station and require their own power supply and a dedicated communication mode, forming an architecture that is fragmented, relatively complex and expensive, and unsuitable for an installation comprising a plurality of autonomous vehicles and a plurality of docking stations.

The present disclosure aims to overcome these disadvantages by proposing a novel architecture for a charging assembly for autonomous vehicles which makes it possible to integrate and combine, in a single physical entity, locating functions and functions for transmitting different types of information, in particular operating safety information. Such an architecture eliminates the need for multiple infrastructure requirements, unlike conventional solutions that need to be equipped with chargers connected to the mains, stationary locating beacons powered, for example, by an Ethernet network, and radio transmission safety systems.

Another aim of the present disclosure is to propose a charging assembly with a smaller space requirement and a lower final cost.

### SUMMARY

The present disclosure improves the situation.

According to a first aspect of the present disclosure, a charging assembly for autonomous vehicles is proposed, comprising:
a charging docking station configured to be arranged fixedly in a working area, said charging docking station comprising a battery charger, a first operating safety monitor configured to generate and transmit operating safety information, and a first wireless communication transmitter configured to receive said operating safety information transmitted by the first operating safety monitor and to generate and transmit a safety frame comprising said operating safety information;
an autonomous-navigation vehicle configured to move in the working area, said vehicle comprising a rechargeable electric battery able to be electrically connected to the terminals of the battery charger, a second operating safety monitor connected to the rechargeable electric battery, and a second wireless communication transmitter configured to receive said safety frame comprising said safety information transmitted by the first wireless communication transmitter and to transmit said safety information to the second operating safety monitor, said second operating safety monitor being configured to process said operating safety information.

According to one aspect, the first wireless communication transmitter is configured to transmit position information of the docking station to the second wireless communication transmitter and the vehicle further comprises a navigation monitor configured to calculate the location of the vehicle in relation to the charging docking station in the working area based on the position information.

According to one aspect, the assembly comprises a plurality of charging docking stations and a plurality of autonomous vehicles, each autonomous vehicle being configured to receive position information originating from at least three of the charging docking stations of the working area in order to calculate the location of said autonomous vehicle by triangulation.

The features disclosed in the paragraphs below may optionally be implemented independently of each other or in combination with each other:

The first wireless communication transmitter and the second communication transmitter are wireless radio transmitters, the radio communication between the first transmitter and the second transmitter being established periodically.

The first communication transmitter is configured to encapsulate the safety information originating from the first operating safety monitor in a safety frame and the second communication transmitter is configured to decapsulate the safety frame in order to extract the safety information.

According to one aspect, the first wireless communication transmitter and the second wireless communication transmitter are wireless radio transmitters and receivers configured to transmit and receive information. Communication between the two transmitters is bidirectional. Therefore, communication between the charging docking station and the vehicle is bidirectional.

According to one aspect, the second wireless communication transmitter may be configured to transmit vehicle status information and location information of the vehicle in the working area to the first wireless communication transmitter. The vehicle status information may, for example, indicate that the motor is off and the vehicle is stationary. The vehicle status information may also indicate, for example, that the vehicle has suffered an impact.

According to another aspect, the assembly further comprises an emergency stop button connected to the first operating safety monitor.

According to one aspect, the second operating safety monitor is configured to cut the electrical power supply connection between an electric motor and the battery in order to stop the vehicle motor on the basis of operating safety information originating from the charging docking station, or to engage a safety stop function of the vehicle motor on the basis of operating safety information originating from the charging docking station.

Preferably, the assembly further comprises an electricity network suitable for supplying said charging docking station.

According to another aspect, a method is proposed for managing the charging of an autonomous vehicle in a charging assembly as defined above, comprising the following steps:
navigating the mobile autonomous vehicle towards a charging docking station in a working area based on position information transmitted by at least one charging docking station;
docking with the charging docking station with which the vehicle is associated and charging the rechargeable battery;
stopping the autonomous vehicle remotely when it receives operating safety information originating from the charging docking station.

According to one aspect, the autonomous vehicle is stopped according to the following steps:
generation of operating safety information by the first operating safety monitor;
transmission of operating safety information from the first operating safety monitor to the first communication transmitter;
encapsulation of the operating safety information in a safety frame by the first communication transmitter;
transmission of the safety frame from the first communication transmitter to the second communication transmitter;
decapsulation of the safety frame by the second communication transmitter in order to extract the safety information;
transmission of the safety information from the second communication transmitter to the second operating safety monitor;
cutting of the electrical power supply connection between a motor and the battery in order to stop the vehicle motor.

Preferably, the safety information is generated by an emergency stop button connected to the first operating safety monitor of a charging docking station.

### BRIEF DESCRIPTION OF THE DRAWINGS

Further features, details and advantages will become apparent on reading the following detailed description, and on studying the appended drawings, in which:

FIG. 1

FIG. 1 shows a schematic view of a charging assembly for an autonomous vehicle according to one aspect, comprising a charging docking station and an autonomous vehicle.

FIG. 2

FIG. 2 shows a schematic view of a variant of the charging assembly for an autonomous vehicle of FIG. 1.

FIG. 3

FIG. 3 shows a schematic view of another aspect of a charging assembly comprising three charging docking stations and an autonomous vehicle.

FIG. 4

FIG. 4 shows a method for managing charging according to one aspect.

FIG. 5

FIG. 5 shows a method for managing the stopping of the autonomous vehicle according to one aspect.

### DETAILED DESCRIPTION

Elements that are identical or similar have been given the same references in the different figures.

In the context of the present disclosure, “environment” means, for example, a warehouse, a production plant or any other industrial space in which a lightweight vehicle moves.

In the context of the present disclosure, the lightweight autonomous-navigation vehicle that moves autonomously in an environment may, for example, be a handling trolley or any other mobile handling machine or an autonomous mobile robot.

In the context of the present disclosure, “operating safety information” should be understood to mean a safety command that requires the vehicle to be stopped. This safety information is generated by a stop button situated at the docking station when it is activated by an operator.

In the context of the present disclosure, “position information” should be understood to mean a set of coordinates indicating the location of the docking stations in a working area. This information is used to feed the navigation algorithms of the mobile autonomous vehicle in order to determine the position of the vehicle in relation to the docking stations situated in the working area in which the vehicle moves in order to enable an on-board computer of the vehicle to calculate a navigation trajectory to move towards a predefined docking station.

In reference to FIG. 1, a charging assembly for a motorized autonomous vehicle 1 according to one aspect is shown.

Such an assembly 1 comprises, for example, a charging docking station 20 and an autonomous electric vehicle 10. This assembly may further comprise an electricity network 3 powering the docking station 20. This assembly is installed in a working area, for example a storage warehouse.

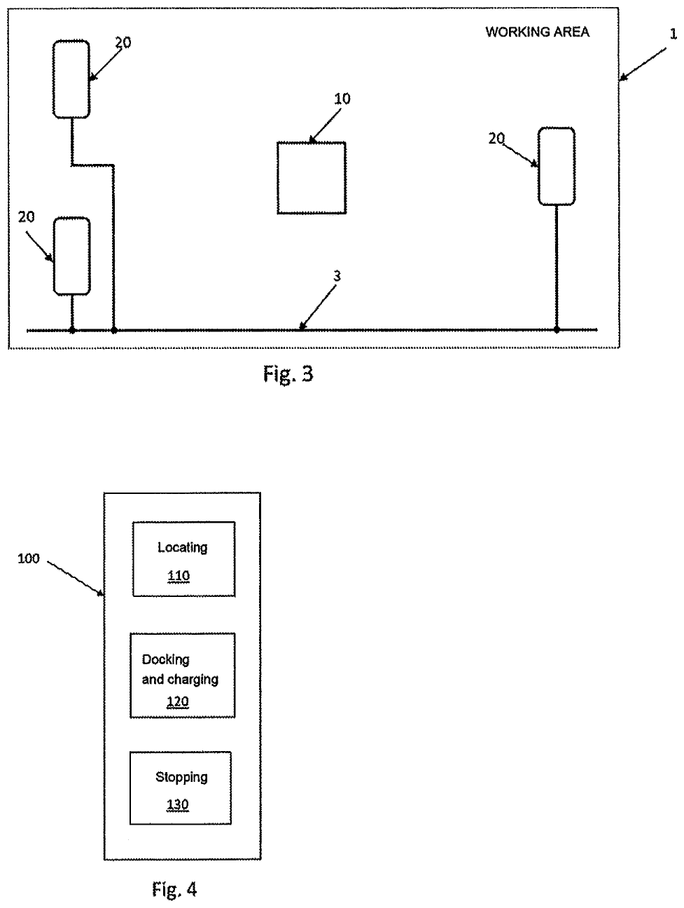

According to another aspect shown in FIG. 3, the charging assembly 1 comprises three docking stations 20 and an autonomous vehicle 10. The number of docking stations and the number of autonomous vehicles circulating in the working area are not limiting. Preferably, each autonomous vehicle may be associated with at least three docking stations 20. The autonomous vehicle operates in the working area and can approach one of the stationary docking stations for charging purposes, connecting electrically to the terminals of the charger installed in the docking station.

The autonomous electric vehicle 10 generally comprises one or more wheels, which are not shown in FIG. 1, coupled to an electric motor for providing traction or propulsion for moving the vehicle. The wheel may be a non-directional drive wheel that moves the vehicle forward or backwards in a main direction of movement linked to the vehicle, the direction of movement being perpendicular to the axis of rotation of the non-directional wheels. The wheel may be a directional drive wheel. The wheel can be oriented by pivoting about a vertical pivot axis in order to steer the vehicle along its journey. Depending on the size and geometry of the vehicle, the number of wheels and the load distribution, several drive wheel configurations may be considered in order to ensure the correct operation of the drive wheel or wheels.

According to one aspect, each charging docking station 20 comprises a battery charger 21 provided with two connection terminals 25, a first operating safety monitor 22 and a first wireless communication transmitter 23. The first operating safety monitor is configured to generate operating safety information and to transmit the operating safety information to the first wireless communication transmitter 23. The first wireless communication transmitter 23 is configured to transmit operating safety information and position information of the docking station towards the vehicle 10. The first transmitter 23 is configured to generate a safety frame 4 comprising the received operating safety information and to transmit the safety frame comprising the operating safety information towards the vehicle 10.

The vehicle 10 comprises a battery 11 which stores and releases the energy required for the autonomous operation of the drive system, a second operating safety monitor 12 which is able to process safety information originating from the docking station in order to control the stopping of the electrical power supply of the motor and a second communication transmitter 13 configured to exchange data with the docking station. More precisely, the second transmitter 13 is configured to receive the safety frame 4 comprising the operating safety information and the position information transmitted by the first transmitter 23. The operating safety information is transmitted to the second operating safety monitor 12 for processing.

According to one aspect, the first transmitter 23 and the second transmitter may be radio transmitters/receivers configured to transmit and receive information. Therefore, the first transmitter 23 may, for example, transmit information towards the vehicle and receive information originating from the vehicle and the second transmitter 13 may, for example, receive data originating from the charging docking station and transmit data towards the charging docking station. Therefore, communication between the charging docking station and the vehicle is bidirectional.

According to one aspect, the vehicle further comprises a navigation monitor 14 which is able to process position information originating from one or more docking stations in order to locate the vehicle in the working area. The position information is transmitted to the navigation monitor 14 by the second transmitter 13.

According to one aspect, the second operating safety monitor 12 is configured to generate vehicle status information and transmit it to the second communication transmitter 13. The navigation monitor 14 is configured to calculate the location information of the vehicle in the working area and transmit it to the second wireless communication transmitter 13. The second wireless communication transmitter 13 is configured to transmit this vehicle status information and this location information to the first communication transmitter 23. The vehicle status information may, for example, indicate that the motor is off and the vehicle is stationary. The vehicle status information may also indicate, for example, that the vehicle has suffered an impact.

The battery 11 of the vehicle is equipped with two terminals 15 suitable for connecting to the terminals 25 of the battery charger 21 of the charging docking station 20 when the autonomous vehicle 10 is docked with the station.

According to one aspect, the battery 11 comprises rechargeable accumulators that are able to store and release the energy required for the autonomous operation of the drive system. According to one aspect, the accumulators comprise an Ni-MH battery. According to another aspect, the accumulators comprise a Li-ion battery.

Due to the presence of the two communication transmitters 23, 13, a radio link 2 is periodically established between the vehicle 10 and the docking stations 20 of the working area. Preferably, each vehicle communicates with at least one station of the working area. According to another aspect, each vehicle can communicate with all of the stationary docking stations present in the working area when the range of the radio link allows.

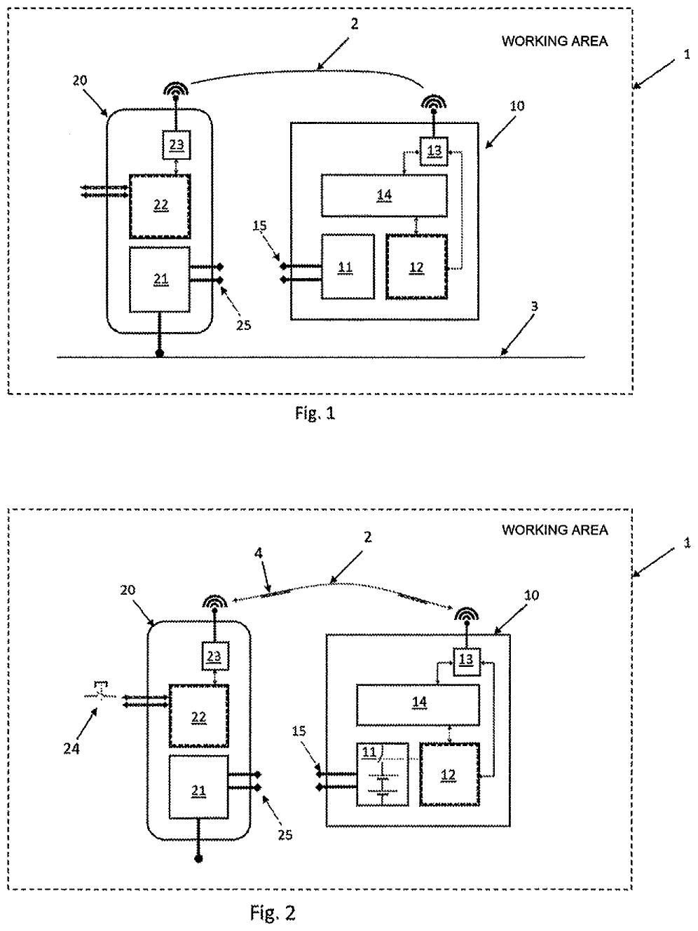

According to one particularly advantageous aspect of the present disclosure, the radio communication link 2 between the first communication transmitter 23 and the second communication transmitter 13 allows the position information of the docking stations and the operating safety information to be transmitted. Therefore, in the example of FIG. 2, the transmitter 23 of the charging docking station 20 is configured to transmit position information of the associated station and the operating safety information to the second transmitter 13 of the vehicle 10.

The operating safety information is generated by the first operating safety monitor 22 of the charging docking station 20.

For example, and in reference to FIG. 2, the docking station may further comprise an emergency stop button 24 connected to the inputs of the first operating safety monitor 22. In the event of an emergency, an operator can activate the emergency stop button, which sends a signal indicating the stopping of the vehicle to the first operating safety monitor 22, which generates a first item of operating safety information and transmits it to the first communication transmitter 23.

For this purpose, the communication transmitter 23 is configured to encapsulate the operating safety information to be transmitted to the vehicle on radio communication frames 4 so as to guarantee the safety of the information transmitted.

The safety frames 4 are received by the second safety transmitter 13 which transmits them to the second operating safety monitor 12 in order to control the motor of the vehicle. More precisely, the second transmitter 13 is configured to decapsulate the operating safety information originating from the transmitter before transmitting it to the second safety monitor.

The second operating safety monitor 12 is configured to order the motor to stop, and in particular to stop the motor when the safety information represents an emergency situation requiring the motor to be stopped.

The position information originating from the docking stations is processed by the navigation monitor 14 and allows the autonomous vehicle to determine its position in the working area in relation to the docking stations and to calculate a trajectory to move towards a predefined docking station on which the vehicle will charge its battery.

The navigation monitor 14 is configured to control the navigation of the vehicle from docking station to docking station in order to dock for charging purposes based on location information originating from one or more docking stations. The navigation monitor 14 is able to determine the position of the vehicle based on the data transmitted by the docking stations in the working area by triangulation and to calculate a trajectory to be followed by the vehicle in the working area towards the associated charging docking station.

The safety information and the position information are therefore processed by two different monitors, the second operating safety monitor 12 and the navigation monitor 14, which are both integrated into the vehicle 10.

The second operating safety monitor 12 is coupled to the motor of the vehicle 10 and configured to control the motor. The second operating safety monitor 12 is able to cut off the electrical power supply of the motor so as to cancel the torque in order to stop the vehicle.

The second operating safety monitor 12 is connected to the second communication transmitter 13, which receives the safety frames originating from the docking station.

The navigation monitor 14 is connected to the second communication transmitter 13, which receives the position information originating from several docking stations, and to the second operating safety monitor 12.

Making the charging docking station able to provide an electrical power supply and transmit position information of the station and safety information, eliminates the need for multiple infrastructure requirements. Due to the specific configuration of the charging assembly of the present disclosure, it is therefore possible to combine three functions, i.e.:
charging the autonomous vehicle;
geographically locating the autonomous vehicle in relation to the docking stations;
exchanging safety information between the docking stations, which are stationary in the working area, and the autonomous vehicle.

In known solutions, the location function and the safety information are processed by separate modules. The location function is provided, for example, by stationary locating beacons powered, for example, by an Ethernet network. The safety information is transmitted by radio transmission safety systems which require their own electrical power supply and a dedicated communication mode. Therefore, a large number of modules and infrastructure requirements need to be catered for in order to provide all three functions.

In reference to FIG. 4, the various steps of implementing a method for charging an autonomous vehicle using the charging assembly of FIG. 1 are described below.

When the vehicle 10 detects that the charge level of its battery requires charging or when it has completed its assigned operations, the vehicle 10 moves to find a charging docking station.

In a locating step 110, the transmitter 13 installed on the autonomous vehicle 10 which is operating in the working area receives location information originating from the transmitter 23 installed on the docking station 20. Preferably, the vehicle receives location information originating from three docking stations.

The location information is transmitted by the second transmitter 13 from the vehicle to the navigation monitor 14 and is processed in order to determine the geographical position of the autonomous vehicle 10 in the working area in relation to the docking station 20. Based on the geographical position of the vehicle, the navigation monitor 14 determines the trajectory to be followed by the vehicle towards the docking station 20 in order to charge the battery.

In a docking and charging step 120, the vehicle 10 moves along the trajectory determined by the navigation monitor 14 so as to approach the docking station 20 in order to dock and charge its battery. The vehicle 10 moves until the terminals 15 of the battery 11 are connected to the terminals 25 of the charger 21 of the station. Charging is carried out autonomously. The circuit inside the docking station detects the connection established between the vehicle and the charger of the station and activates charging on its terminals 25.

In a step of stopping the vehicle 130, while the vehicle is moving towards the docking station, safety information may be generated by the first operating safety monitor 22 of the docking station and transmitted to the autonomous vehicle. This safety information indicates, for example, a command to stop the vehicle. In response to the safety information, the second operating safety monitor 12 cuts off the electrical power supply of the electric motor of the vehicle 10 or activates a safety function (for example, STO: Safe Torque Off, SSI: Safe Stop, or SBC: Safe Brake Control) to stop the motors in order to immobilize the vehicle.

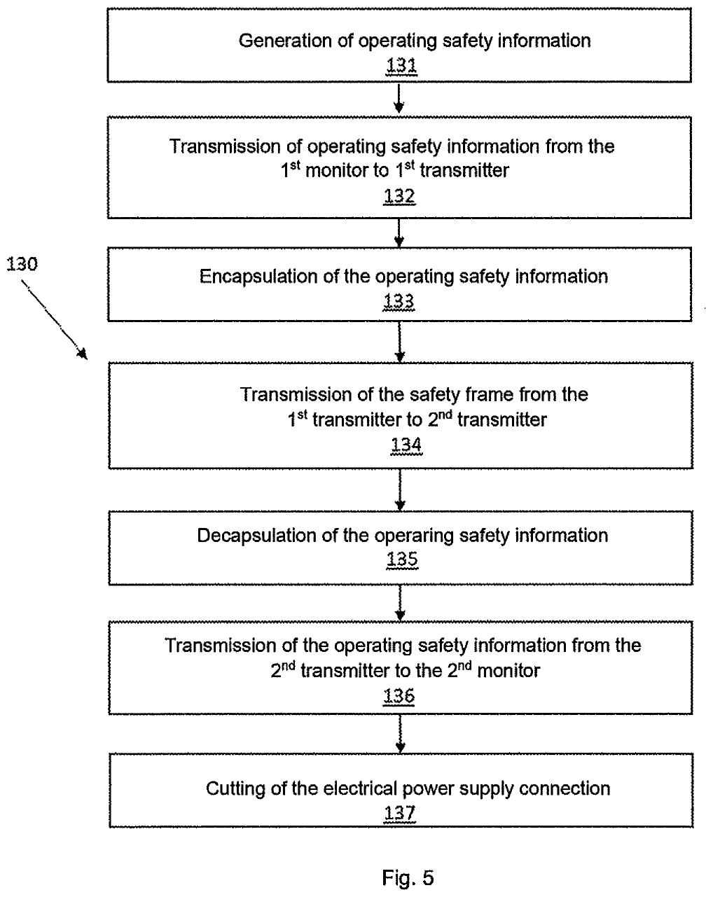

In reference to FIG. 5, an aspect of an emergency stop of the vehicle is described in greater detail.

In a step 131, an emergency stop command is triggered, for example by means of an emergency stop button 24 connected to a safety input of a station. The operating safety monitor 22 of the station generates operating safety information.

In a step 132, the first operating safety monitor 22 of the station transmits the operating safety information to the first communication transmitter 23.

In a step 133, the operating safety information is encapsulated in a safety frame 4 by the first communication transmitter 23.

In a step 134, the safety frame 4 is transmitted by the first transmitter 23 of the station to the second transmitter 13 of the vehicle.

In a step 135, the safety frame 4 is decapsulated by the second communication transmitter 13 and the operating safety information is extracted from the safety frame by the second communication transmitter 13.

In a step 136, the second transmitter 13 transmits the safety information to the second operating safety monitor 12.

In a step 137, the second operating safety monitor 12 cuts off the electrical power supply of the motor of the vehicle in response to the received safety information.

Due to the direct integration of the operating safety monitors in the docking stations and in the autonomous vehicle, the charging assembly of the present disclosure combines several functions:
the function of charging an autonomous vehicle;
the function of geographically locating the vehicle, enabling the autonomous vehicle to determine its position in relation to the stations and making it possible for it to navigate towards the station chosen for charging;
the safety function allowing the vehicle to be stopped remotely, without the operator needing to physically approach the vehicle to activate the emergency stop button situated on the vehicle.

The solution proposed by the present disclosure makes it possible to monitor, in an optimal and safe manner, work or production stations equipped with several autonomous vehicles, by giving the docking station the ability to remotely stop the vehicle operating in a working area.

### INDUSTRIAL APPLICATION

The present technical solutions can be used in a variety of industrial applications, such as the automotive industry, the agri-food industry and the logistics industry, in order to charge machines of the industrial handling trolley type for transporting spare parts or items between work stations or work units in order to optimize the logistics flow while maintaining operator safety.

What is claimed is:

1. A charging assembly for autonomous vehicles comprising:
a charging docking station configured to be arranged fixedly in a working area, said charging docking station comprising a battery charger, a first operating safety monitor configured to generate and transmit operating safety information, and a first wireless communication transmitter configured to receive said operating safety information transmitted by the first operating safety monitor and to generate and transmit a safety frame comprising said operating safety information;
an autonomous-navigation vehicle configured to move in the working area, said vehicle comprising a rechargeable electric battery able to be electrically connected to the terminals of the battery charger, a second operating safety monitor connected to the rechargeable electric battery, and a second wireless communication transmitter configured to receive said safety frame comprising said safety information transmitted by the first wireless communication transmitter and to transmit said safety information to the second operating safety monitor, said second operating safety monitor being configured to process said operating safety information.

2. The assembly as claimed in claim 1, in which the first wireless communication transmitter is configured to transmit position information of the docking station to the second wireless communication transmitter, the vehicle further comprising a navigation monitor configured to calculate the location of the vehicle in relation to the charging docking station in the working area based on said position information.

3. The assembly as claimed in claim 2, comprising a plurality of charging docking stations and a plurality of autonomous vehicles, each autonomous vehicle being configured to receive position information originating from at least three of the charging docking stations of the working area in order to calculate the location of said autonomous vehicle by triangulation.

4. The assembly as claimed in claim 1, in which the first wireless communication transmitter and the second communication transmitter are wireless radio transmitters, the radio communication between the first transmitter and the second transmitter being established periodically.

5. The assembly as claimed in claim 4, in which the first wireless communication transmitter and the second wireless communication transmitter are wireless radio transmitters and receivers configured to transmit and receive information.

6. The assembly as claimed in claim 5, in which the second wireless communication transmitter is configured to transmit vehicle status information and location information of the vehicle to the first wireless communication transmitter.

7. The assembly as claimed in claim 1, in which the first communication transmitter is configured to encapsulate the safety information originating from the first operating safety monitor in a safety frame and the second wireless communication transmitter is configured to decapsulate the safety frame in order to extract the safety information.

8. The assembly as claimed in claim 1, further comprising an emergency stop button connected to the first operating safety monitor.

9. The assembly as claimed in claim 1, in which the second operating safety monitor is configured to cut the electrical power supply connection between an electric motor and the battery in order to stop the vehicle motor on the basis of operating safety information originating from the charging docking station, or to engage a safety stop function of the vehicle motor on the basis of operating safety information originating from the charging docking station.

10. The assembly as claimed in claim 1, further comprising an electricity network suitable for supplying said charging docking station.

11. A method for managing the charging of an autonomous vehicle in a charging assembly as claimed in claim 1, comprising the following steps:
navigating the mobile autonomous vehicle towards a charging docking station in a working area based on position information transmitted by at least one charging docking station;
docking with the charging docking station with which the vehicle is associated and charging the rechargeable battery;
stopping the autonomous vehicle remotely when it receives operating safety information originating from the charging docking station.

12. The method as claimed in claim 11, in which the autonomous vehicle is stopped according to the following steps:
generation of operating safety information by the first operating safety monitor;
transmission of operating safety information from the first operating safety monitor to the first communication transmitter;
encapsulation of the operating safety information by the first communication transmitter in a safety frame;
transmission of the safety frame from the first communication transmitter to the second communication transmitter;
decapsulation of the safety frame by the second communication transmitter in order to extract the safety information;
transmission of the safety information from the second communication transmitter to the second operating safety monitor;
cutting of the electrical power supply connection between the motor and the battery in order to stop the vehicle motor.

13. The method as claimed in claim 11, in which the safety information is generated by an emergency stop button connected to the first operating safety monitor of a charging docking station.
